(19) United States
(12) Patent Application Publication
(10) Pub. No.: US 2006/0292364 A1
(43) Pub. Date: Dec. 28, 2006

(54) Glass reinforcement strip

(75) Inventors: David I. Oreck, New Orleans, LA (US); Frederick Heyl, Picayune, MS (US)

Correspondence Address: THE OLLILA LAW GROUP LLC, 2060 BROADWAY, SUITE 300, BOULDER, CO, 80302, US

(73) Assignee: Park VII Aviation, New Orleans, LA (US)

(21) Appl. No.: 11/166,607

(22) Filed: Jun. 24, 2005

(51) Int. Cl. B32B 15/04

(52) U.S. Cl. 428/343; 428/354

(57) ABSTRACT

A glass reinforcing strip for a glass pane is provided according to an embodiment of the invention. The glass reinforcing strip includes a first substantially planar contact portion formed of a sheet material and a second substantially planar contact portion formed of the sheet material and substantially coplanar with the first contact portion. The glass reinforcing strip further includes a displaced portion formed of the sheet material and located between the first contact portion and the second contact portion and non-coplanar with the first contact portion and the second contact portion. The displaced portion creates at least some rigidity in the glass reinforcing strip.

### TECHNICAL FIELD

The present invention relates to a glass reinforcement strip.

### BACKGROUND OF THE INVENTION

Wind damage to buildings and structures can occur during periods of high wind and/or severe storms. One relative weak spot in a typical building is a window. Ordinary window glass, while being hard, is not terribly strong against side loads. A high wind loading on a window pane can cause the glass to break or shatter. Window replacement can be costly and bothersome. A broken window can also let in rain, snow, insects, animals, intruders, etc.

In addition, research into hurricane damage has shown that a broken window or windows can enable high winds to enter a structure and cause further damage, such as damage to walls, siding, roofing, etc. These structural components are built to withstand relatively high outside pressures but do not exhibit the same strength and interlocking nature for high inside pressures. A common result is that when upwind windows fail, the high winds subsequently enter the structure and cause significant damage to the downwind regions of the structure. For example, a portion of the roof (or even the entire roof) may be blown upward and off of the structure.

One approach in the prior art has been the installation of plywood or other sheeting over windows. While effective, installation of protective sheeting has drawbacks. Installation of protective sheeting is expensive, especially for large sized windows or where the structure includes a large number of windows. The cost of plywood continues to increase, and can reach exorbitant levels before a large, oncoming hurricane. Before significant storms, such as hurricanes, plywood and other suitable sheeting can become scarce. In addition, installation of protective sheeting over windows is relatively time-consuming, as each sheet may require cutting and the installation of multiple fasteners.

Another approach in the prior art has been the installation of hurricane shutters that can be closed over windows as a storm approaches. Hurricane shutters offer high strength and can be designed to aesthetically fit with the structure. However, they have drawbacks. Protective shutters are costly, especially for large sized windows or where the structure includes a large number of windows. In addition, they require upkeep. Further, protective shutters cannot be quickly installed (such as immediately preceding severe weather), and may require tools and construction expertise in order to install.

Another approach in the prior art has been the installation of hurricane-rated window glass. The hurricane-rated window glass can comprise tempered or strengthened glass. Alternatively, hurricane-rated window glass can comprise glass panes sandwiched over an inner clear layer, such as plastic, in order to form a strong and impact resistant window. In yet another alternative, a window pane can comprise a glass pane having a film bonded to at least one side. The film serves to hold together the glass pieces if the window fails in order to prevent shards of glass from flying through the air. However, this prior art approach also has drawbacks. Hurricane-rated window glass is costly, especially for large sized windows or where the structure includes a large number of windows. In addition, hurricane-rated window glass cannot be quickly installed, such as immediately preceding severe weather. Further, the large cost of retro-fitting existing windows strongly discourages upgrading to hurricane-rated window glass.

### SUMMARY OF THE INVENTION

A glass reinforcing strip for a glass pane is provided according to an embodiment of the invention. The glass reinforcing strip comprises a first substantially planar contact portion formed of a sheet material and a second substantially planar contact portion formed of the sheet material and substantially coplanar with the first contact portion. The glass reinforcing strip further comprises a displaced portion formed of the sheet material and located between the first contact portion and the second contact portion and non-coplanar with the first contact portion and the second contact portion. The displaced portion creates at least some rigidity in the glass reinforcing strip.

A glass reinforcing strip for a glass pane is provided according to an embodiment of the invention. The glass reinforcing strip comprises a first substantially planar contact portion formed of a sheet material and a second substantially planar contact portion formed of the sheet material and substantially coplanar with the first contact portion. The glass reinforcing strip further comprises a substantially stackable displaced portion formed of the sheet material and located between the first contact portion and the second contact portion and non-coplanar with the first contact portion and the second contact portion. The substantially stackable displaced portion creates at least some rigidity in the glass reinforcing strip.

A glass reinforcing strip for a glass pane is provided according to an embodiment of the invention. The glass reinforcing strip comprises a first substantially planar contact portion formed of a sheet material and a second substantially planar contact portion formed of the sheet material and substantially coplanar with the first contact portion. The glass reinforcing strip further comprises a displaced portion formed of the sheet material and located between the first contact portion and the second contact portion and non-coplanar with the first contact portion and the second contact portion. The displaced portion creates at least some rigidity in the glass reinforcing strip. The glass reinforcing strip further comprises a bonding agent deposited on at least a portion of the first contact portion and the second contact portion. The bonding agent is adapted to bond the glass reinforcing strip to the glass plane.

A glass reinforcing strip for a glass pane is provided according to an embodiment of the invention. The glass reinforcing strip comprises a first substantially planar contact portion formed of a sheet material and a second substantially planar contact portion formed of the sheet material and substantially coplanar with the first contact portion. The glass reinforcing strip further comprises a displaced portion formed of the sheet material and located between the first contact portion and the second contact portion and non-coplanar with the first contact portion and the second contact portion. The displaced portion creates at least some rigidity in the glass reinforcing strip. The glass reinforcing strip further comprises a flexible reinforcing layer adhered to the first contact portion and the second contact portion. The adhesive cloth is adapted to bond to the glass plane and hold the glass reinforcing strip to the glass plane.

### BRIEF DESCRIPTION OF THE DRAWINGS

The same reference number represents the same element on all drawings. It should be noted that the drawings are not necessarily to scale.

FIG. 1 shows a glass reinforcing strip according to an embodiment of the invention.

FIG. 2 is a top view showing an edge of the glass pane and showing the glass reinforcing strip in profile.

FIGS. 3A-3D show various profile embodiments of the displaced portion.

FIG. 4 shows an embodiment of the glass reinforcing strip that includes more than one displaced portion.

FIG. 5 shows a glass reinforcing strip being used in conjunction with a flexible reinforcing layer according to an embodiment of the invention.

### DETAILED DESCRIPTION OF THE INVENTION

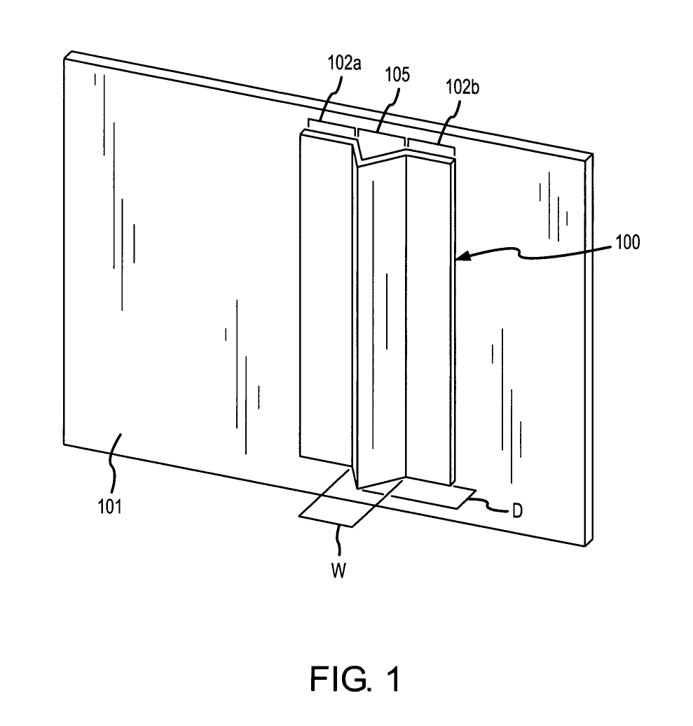

FIGS. 1-5 and the following descriptions depict specific embodiments to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will also appreciate that the features described below can be combined in various ways to form multiple variations of the invention. As a result, the invention is not limited to the specific embodiments described below, but only by the claims and their equivalents.

FIG. 1 shows a glass reinforcing strip 100 according to an embodiment of the invention. The glass reinforcing strip 100 includes at least a first contact portion 102a, a second contact portion 102b, and a displaced portion 105. In use, the first contact portion 102a and the second contact portion 102b affix to a glass pane 101. As a result, the glass reinforcing strip 100 reinforces and protects the glass pane 101. The glass reinforcing strip 100 provides additional strength and rigidity to the glass pane 101. The glass reinforcing strip 100 prevents breakage of the glass pane 101. Even if the glass pane 101 fractures, the glass reinforcing strip 100 can hold together the individual pieces and keep the pieces from blowing through the air.

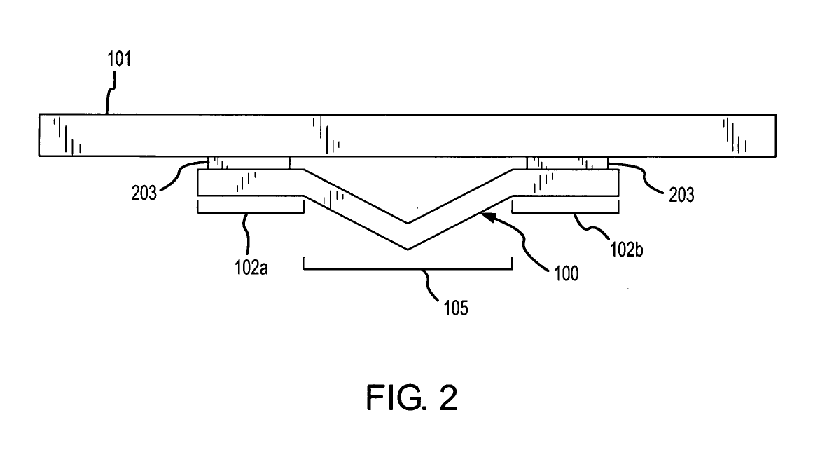

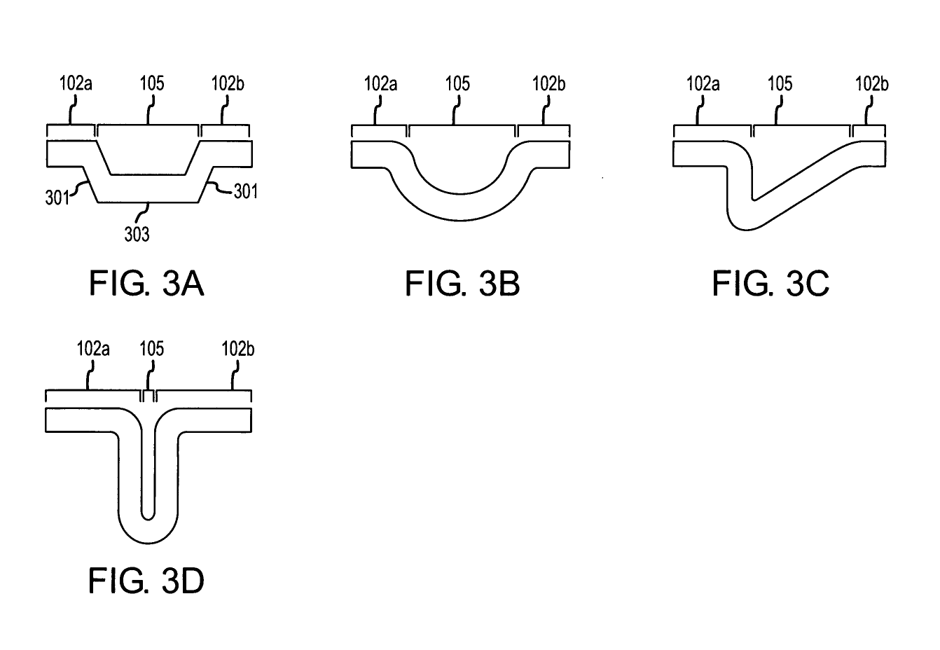

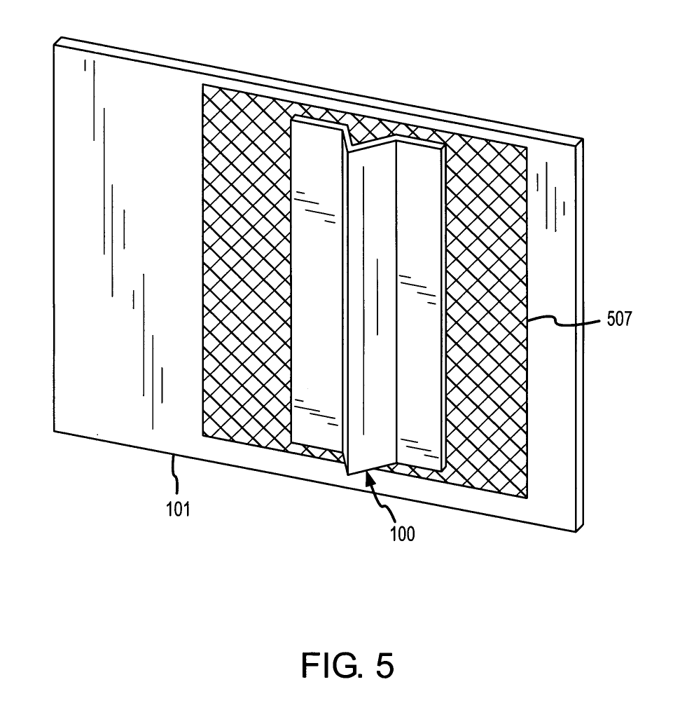

The glass reinforcing strip 100 can be substantially removably or substantially permanently affixed to the glass pane 101. The glass reinforcing strip 100 can be reusable. In one embodiment, the glass reinforcing strip 100 is affixed to the glass pane 101 by a bonding agent 203 (see FIG. 3 and the accompanying discussion). A bonding agent can be applied to the contact portions 102a and 102b in order to affix the glass reinforcing strip 100 to the glass pane 101. Alternatively, the glass reinforcing strip 100 can include an integral bonding agent 203 (see FIG. 2 and the accompanying discussion). The integral bonding agent 203 can include a tear-off protective cover strip (not shown) that can be removed from the bonding agent 203 before installation. In yet another embodiment, the glass reinforcing strip 100 is affixed to the glass pane 101 by a flexible reinforcement layer 507 (see FIG. 5 and the accompanying discussion).

The glass reinforcing strip 100 can be added to one or both sides of a glass pane 101, such as a window. Multiple glass reinforcing strips 100 can be affixed to a glass pane 101. The glass reinforcing strip 100 can be applied to new windows or can be retrofitted to existing windows. Due to the minimal installation required in order to affix a glass reinforcing strip 100 to a glass pane 101, windows of a house or other structure can be reinforced immediately before (and even during) a storm or high wind conditions.

The glass reinforcing strip 100 can be affixed to the glass pane 101 in any desired or needed orientation. The glass reinforcing strip 100 can be cut to fit the glass pane 101. The glass reinforcing strip 100 can be provided in bulk lengths.

The displaced portion 105 can provide a greater strength and rigidity than a flat member. The displaced portion 105 includes a width W and a depth D. Both the width W and the depth D can vary. The strength and rigidity of the displaced portion 105 can be varied according to the type of material used, according to the thickness, and according to a geometry of the displaced portion 105 (i.e., the width W, the depth D, and the profile of the displaced portion 105).

The glass reinforcing strip 100 can be formed in many ways. The glass reinforcing strip 100 can be molded, pressed, stamped, folded, joined, assembled, etc. The glass reinforcing strip 100 can be formed of any suitable material. The glass reinforcing strip 100 in one embodiment is formed of a partially or completely transparent material. The glass reinforcing strip 100 in one embodiment is formed of a substantially rigid material. The glass reinforcing strip 100 in another embodiment is formed of a partially flexible material. A partially flexible glass reinforcing strip 100 can better fit to the glass pane 101 if the glass pane 101 includes curves, ripples, or other imperfections.

Another feature of the invention is that the glass reinforcing strip 100 can comprise stackable glass reinforcing strips 100, wherein the displaced portions 105 comprise stackable profiles. Consequently, for higher wind loads or larger windows, individual glass reinforcing strips 100 can be stacked on top of each other. Each new glass reinforcing strip 100 can be affixed to the glass reinforcing strip 100 below it. A stack of multiple glass reinforcing strips 100 can bond to each other in order to form an even stronger reinforcement structure.

FIG. 2 is a top view showing an edge of the glass pane 101 and showing the glass reinforcing strip 100 in profile. This figure also shows the bonding agent 203 that affixes the glass reinforcing strip 100 to the glass pane 101. The bonding agent 203 can substantially removably or substantially permanently affix the glass reinforcing strip 100 to the glass pane 101. Through use of a suitable bonding agent 203, the glass reinforcing strip 100 can be reusable and can be affixed to the glass pane 101 more than once.

In one embodiment, the bonding agent 203 can comprise any manner of suitable adhesive. In another embodiment, the bonding agent 203 can comprise a carrier (such as a tape or strip) that is impregnated with any manner of suitable adhesive. For example, the bonding agent 203 can comprise a double-sided tape or adhesive strip.

FIGS. 3A-3D show various profile embodiments of the displaced portion 105. In FIG. 3A, the displaced portion 105 comprises angled sidewalls 301 and a flat displaced section 303. In one embodiment, the displaced portion 105 is substantially rectangular, and can comprise substantially right-angled bends. In FIG. 3B, the displaced portion 105 is curved, and can be substantially semi-circular. In FIG. 3C, the displaced portion 105 is substantially triangular. In FIG. 3D, the displaced portion 105 comprises two lengths folded back on each other.

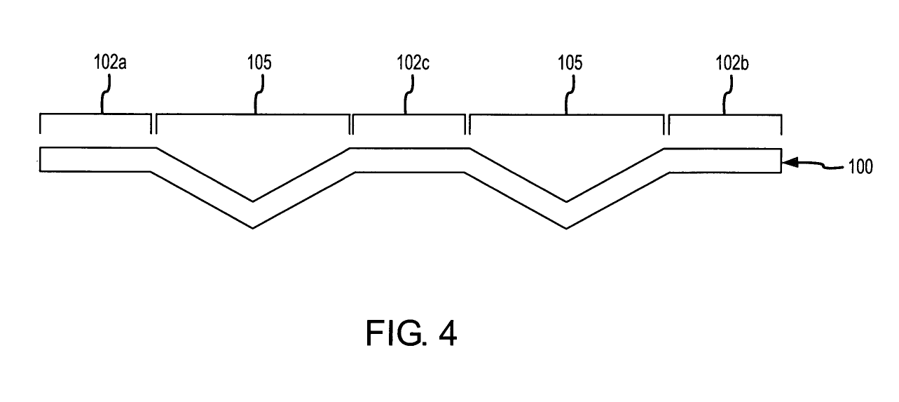

FIG. 4 shows an embodiment of the glass reinforcing strip 100 that includes more than one displaced portion 105. Any number of displaced portions 105 can be employed. A glass reinforcing strip 100 including multiple displaced portions 105 can be more suitable for larger glass panes. In addition, the glass reinforcing strip 100 can optionally include contact portions 102c between adjacent displaced portions 105.

FIG. 5 shows a glass reinforcing strip 100 being used in conjunction with a flexible reinforcing layer 507 according to an embodiment of the invention. The flexible reinforcing layer 507 can include the bonding agent 203, wherein the flexible reinforcing layer 507 affixes the glass reinforcing strip 100 to the glass pane 101. The flexible reinforcing layer 507 can add additional strength and rigidity to the glass pane 101. In addition, the flexible reinforcing layer 507 can hold together any broken glass pieces in the event that the glass pane 101 does break.

The flexible reinforcing layer 507 can comprise any suitable flexible or semi-flexible material. In one embodiment, the flexible reinforcing layer 507 comprises an adhesive-coated film. In another embodiment, the flexible reinforcing layer 507 comprises an adhesive-impregnated cloth. It should be understood that the various embodiments of the flexible reinforcing layer 507 can include embedded fibers (or other structures) for additional reinforcement strength.

The glass reinforcing strip according the invention can be implemented according to any of the embodiments in order to obtain several advantages, if desired. The glass reinforcing strip according to the invention strengthens a glass pane. The glass reinforcing strip according to the invention prevents breakage. The glass reinforcing strip according to the invention holds the pieces together in the event of breakage in order to prevent flying glass.

The glass reinforcing strip according to the invention is inexpensive, features a quick installation process, requires no tools to install, can be applied to new windows, and can be retro-fitted to existing windows.

A reinforcing installation can use as many glass reinforcing strips as needed. The glass reinforcing strips can be installed on one or both sides of a glass pane and can be oriented as needed. Glass reinforcing strips can be installed on both sides of a window in a perpendicular or opposing orientation for increased strength and rigidity. In addition, multiple glass reinforcing strips can be stacked on top of each other in order to form a stronger reinforcing structure. The glass reinforcing strips are relatively small and can be easily stored when not in use.

What is claimed is:

1. A glass reinforcing strip for a glass pane, comprising:
a first substantially planar contact portion formed of a sheet material;
a second substantially planar contact portion formed of the sheet material and substantially coplanar with the first contact portion; and
a displaced portion formed of the sheet material and located between the first contact portion and the second contact portion and non-coplanar with the first contact portion and the second contact portion, wherein the displaced portion creates at least some rigidity in the glass reinforcing strip.

2. The glass reinforcing strip of claim 1, with the glass reinforcing strip being formed of an at least partially transparent material.

3. The glass reinforcing strip of claim 1, with the glass reinforcing strip being formed of a substantially rigid material.

4. The glass reinforcing strip of claim 1, with the glass reinforcing strip being formed of a partially flexible material.

5. The glass reinforcing strip of claim 1, with the glass reinforcing strip comprising a substantially stackable glass reinforcing strip.

6. The glass reinforcing strip of claim 1, further comprising a bonding agent deposited on at least a portion of the first substantially planar contact portion and on at least a portion of the second substantially planar contact portion.

7. The glass reinforcing strip of claim 6, with the bonding agent comprising a substantially permanent bonding agent.

8. The glass reinforcing strip of claim 6, with the bonding agent comprising a substantially non-permanent bonding agent.

9. The glass reinforcing strip of claim 1, further comprising a flexible reinforcing layer adhered to the first contact portion and the second contact portion, wherein the flexible reinforcing layer is adapted to bond to the glass plane and hold the glass reinforcing strip to the glass plane.

10. A glass reinforcing strip for a glass pane, comprising:
a first substantially planar contact portion formed of a sheet material;
a second substantially planar contact portion formed of the sheet material and substantially coplanar with the first contact portion; and
a substantially stackable displaced portion formed of the sheet material and located between the first contact portion and the second contact portion and non-coplanar with the first contact portion and the second contact portion, wherein the substantially stackable displaced portion creates at least some rigidity in the glass reinforcing strip.

11. The glass reinforcing strip of claim 10, with the glass reinforcing strip being formed of an at least partially transparent material.

12. The glass reinforcing strip of claim 10, with the glass reinforcing strip being formed of a substantially rigid material.

13. The glass reinforcing strip of claim 10, with the glass reinforcing strip being formed of a partially flexible material.

14. The glass reinforcing strip of claim 10, further comprising a bonding agent deposited on at least a portion of the first substantially planar contact portion and on at least a portion of the second substantially planar contact portion.

15. The glass reinforcing strip of claim 14, with the bonding agent comprising a substantially permanent bonding agent.

16. The glass reinforcing strip of claim 14, with the bonding agent comprising a substantially non-permanent bonding agent.

17. The glass reinforcing strip of claim 10, further comprising a flexible reinforcing layer adhered to the first contact portion and the second contact portion, wherein the flexible reinforcing layer is adapted to bond to the glass plane and hold the glass reinforcing strip to the glass plane.

18. A glass reinforcing strip for a glass pane, comprising:
a first substantially planar contact portion formed of a sheet material;
a second substantially planar contact portion formed of the sheet material and substantially coplanar with the first contact portion;
a displaced portion formed of the sheet material and located between the first contact portion and the second contact portion and non-coplanar with the first contact portion and the second contact portion, wherein the displaced portion creates at least some rigidity in the glass reinforcing strip; and
a bonding agent deposited on at least a portion of the first contact portion and the second contact portion, wherein the bonding agent is adapted to bond the glass reinforcing strip to the glass plane.

19. The glass reinforcing strip of claim 18, with the glass reinforcing strip being formed of an at least partially transparent material.

20. The glass reinforcing strip of claim 18, with the glass reinforcing strip being formed of a substantially rigid material.

21. The glass reinforcing strip of claim 18, with the glass reinforcing strip being formed of a partially flexible material.

22. The glass reinforcing strip of claim 18, with the glass reinforcing strip comprising a substantially stackable glass reinforcing strip.

23. The glass reinforcing strip of claim 18, with the bonding agent comprising a substantially permanent bonding agent.

24. The glass reinforcing strip of claim 18, with the bonding agent comprising a substantially non-permanent bonding agent.

25. The glass reinforcing strip of claim 18, with the bonding agent further comprising a flexible reinforcing layer adhered to the first contact portion and the second contact portion, wherein the flexible reinforcing layer is adapted to bond to the glass plane and hold the glass reinforcing strip to the glass plane.

26. A glass reinforcing strip for a glass pane, comprising:
a first substantially planar contact portion formed of a sheet material;
a second substantially planar contact portion formed of the sheet material and substantially coplanar with the first contact portion;
a displaced portion formed of the sheet material and located between the first contact portion and the second contact portion and non-coplanar with the first contact portion and the second contact portion, wherein the displaced portion creates at least some rigidity in the glass reinforcing strip; and
a flexible reinforcing layer adhered to the first contact portion and the second contact portion, wherein the adhesive cloth is adapted to bond to the glass plane and hold the glass reinforcing strip to the glass plane.

27. The glass reinforcing strip of claim 26, with the glass reinforcing strip being formed of an at least partially transparent material.

28. The glass reinforcing strip of claim 26, with the glass reinforcing strip being formed of a substantially rigid material.

29. The glass reinforcing strip of claim 26, with the glass reinforcing strip being formed of a partially flexible material.

30. The glass reinforcing strip of claim 26, with the glass reinforcing strip comprising a substantially stackable glass reinforcing strip.

31. The glass reinforcing strip of claim 26, further comprising a bonding agent deposited on the flexible reinforcing layer.

32. The glass reinforcing strip of claim 31, with the bonding agent comprising a substantially permanent bonding agent.

33. The glass reinforcing strip of claim 31, with the bonding agent comprising a substantially non-permanent bonding agent.
